(19) United States
(12) Patent Application Publication
(10) Pub. No.: US 2006/0281339 A1
(43) Pub. Date: Dec. 14, 2006

(54) Socket for cards

(75) Inventor: Masakazu Ezaki, Tokyo (JP)

Correspondence Address: TAKEUCHI & KUBOTERA, LLP;SUITE 202, 200 DAINGERFIELD ROAD, ALEXANDRIA, VA, 22314, US

(73) Assignee: Hirose Electric Co., Ltd.

(21) Appl. No.: 11/435,769

(22) Filed: May 18, 2006

(30) Foreign Application Priority Data
Jun. 9, 2005 (JP) 2005-168958

(51) Int. Cl. H01R 12/00

(52) U.S. Cl. 439/64

(57) ABSTRACT

The socket for a card comprises a connector portion (16) on the rear side, an opening portion on the front side, and a guiding means (17) for guiding a card (C2) having a width smaller than a width of the opening portion to the proper position for connection with the connector portion. The socket has bottom and top plane portions (11, 25, and 30) for regulating the position of the card in the thicknesswise direction of the card and side face portions (12 and 13) for regulating the position of the card in a widthwise direction to define an accommodation space to receive the card. The guiding means is made by processing part of the bottom and top plane and side face portions (11, 25, 30, 12, and 13) that are made of a metal sheet so as to extend slantwise toward the connector portion (16) and continuously in parallel to the card insertion direction (A).

### BACKGROUND OF THE INVENTION

The present invention relates to a socket for cards, especially a socket capable of selectively receiving two cards having the same width at the front side thereof but different widths at the rear side thereof and connecting such cards to a connector provided in the front end of the socket.

A card is used to extend the function of an electronic device, such as a personal computer. Generally, there is a plurality of cards prepared for the personal computer and they are inserted into a socket provided in the personal computer after suitably selected. If they have the same size, there is no problem. However, when there are two cards having different widths, a card having a large width (hereinafter “wide card”) is cut off on the front side thereof to make the width of the front side equal to the width of a card having a small width (hereinafter “narrow card”) so that a connector provided in the socket are commonly used for connection with connection portions provided on the front side of the wide and narrow cards. An opening of the socket is made fit for the width of the wide card so that both the wide and narrow cards can be inserted into the opening. However, when the narrow card is inserted into the socket, since the position of the card in the widthwise direction thereof is unstable in the socket, the connection portion of the card can fail to be connected to the connector. In order to avoid this problem, a guiding means is provided in the socket so that the narrow card is automatically guided, with the progress of the insertion of the card, to the proper position in the widthwise direction for the connection with the connector.

For example, as shown in FIGS. 7(A) and 7(B), a narrow card C1 and a wide card C2 have the same width on the front side (left-hand side in the drawings) thereof in respect to the insertion direction thereof into the socket, and connection portions are provided at the front edges of the cards for the connection with the connector. The narrow card C1 has the same width on the font and rear side thereof. The width of the wide card C2 is the same as that of the narrow card C1 on the front side thereof but enlarged in the shape of “L” in the middle so that width of the wide card C2 on the rear side thereof is larger than that of the narrow card C1. The cards C1 and C2 have, according to the standard, raised portions C1A and C2A, respectively, at the front edges of one surface thereof (upper surface in FIGS. 7(A) and 7(B)). The widths of the raised portions C1A and C2A are smaller than the widths of the front edges of the cards C1 and C2. The front edges, including the raised portions C1A and C2A, of the narrow and wide cards C1 and C2 have the same shape and the same dimension.

As shown in FIG. 8, a socket 50 for receiving the cards C1 and C2 comprises a socket body 51 and a lid member 52. A connector 53 is provided on the rear side of the socket body 51.

The socket body 51 is made of a metal sheet. The width of the socket body 51 is made to fit the width of the wide card C2. The socket body 51 is composed of a plane portion 51A, a pair of side face portions 51B bent at the side edges of the plane portion 51A, and a pair of flange portions 51C bent at the side edges of the side face portions 51B. When the card is inserted into the socket body 51 in wiping contact with the plane portions 51A, the flange portions 51C guide the upper side edges of the card and determine the positioning of the card in the thicknesswise direction of the card. The flange portions 51C hold the connector 53 and a guide plate 54 as a guiding means. The lid member 52 of a plate type is properly attached on the flange portions 51C.

The connector 53 is placed at the left-hand rear edge of the socket 50 such that it is in touch with the left-hand side face portion 51B. Accordingly, when the narrow card C1 is inserted into the socket 50 along and in contact with the left-hand side face portion 51B, the narrow card C2 is located at the position corresponding to the connector 53.

The guide plate 54 is made of a synthetic resin and positioned on the right-hand rear side in respect to the connector 53 such that it is in touch with the right-hand side face portion 51B. When the narrow card C1 is inserted into the socket 50 at the proper position in touch with the left-hand side face portion 51B, the guide plate 54 is positioned on the right-hand side of the narrow card C1. On the contrary, when the narrow card C1 is inserted into the socket 50 on the right-hand side in respect to the proper position, the guide plate 54 abuts against the narrow card C1 and guides it to the proper position. The guide plate 54 is a two-tiered guide portion having a slanting edge, which faces forwardly and in the direction of the connector 53. A lower guide portion 54A provided in the lower tier has a height smaller than that of the raised portion C1A of the narrow card C1. An upper guide portion 54B is smaller than the lower guide portion 54B and provided on the rear side of the lower guide portion 54A. As shown in FIG. 8, the cards C1 and C2 are inserted into the socket 50 on the upside down condition.

Since the width of the wide card C2 on the rear side thereof is equal to that of the socket 50, the wide card C2 is inserted into the socket 50 at the proper position and connected to the connector 53 without any problem.

Since the narrow card C1 is unstable in the widthwise direction in the socket 50, it can be inserted into the socket 50 on the right-hand side in respect to the proper position. In this case, as sown in FIG. 9, the raised portion C1A abuts against the lower guide portion 54A so that the card C1 is guided in the left-hand direction with the progress of insertion and then the right-hand corner of the card C1 itself abuts against the upper guide portion 54B so that the card C1 is guided in the left-hand direction. Thus, the card C1 is brought into the proper position and connected to the connector 53 smoothly.

However, in such a conventional socket, there have been problems including the high manufacturing cost and operational malfunctions caused by low manufacturing precisions and insufficient strength.

As for the manufacturing cost, since the manufacturing process includes two steps, bending and processing a metal sheet to make a semi-assembly, and then fixing a guide plate of a synthetic resin to the semi-assembly, two kinds of members and assembly work thereof are necessary.

Next, since these members have their own tolerances in manufacturing precisions, when the number of the members increases, the overall tolerance increases. Also, since the two members are assembled in the socket, when an external force is applied on the socket, the two members can be slid out of place. It is also possible that the card cannot be kept in the proper position because of the overall tolerance and/or the slide. Especially, when the card loses an accurate positioning in the thicknesswise direction, the card may ride over the lower guide portion 54A of the guide plate 54. As a result, the card is not brought into smooth contact with the connector and the socket or the card itself can be deformed or damaged.

### SUMMARY OF THE INVENTION

Therefore, an object of the present invention is to provide a card socket having a sufficient structural strength and precision at low manufacturing cost.

In order to achieve the object, according to an aspect of the present invention, a socket for a card comprises a connector portion provided on the rear end of the socket in the card insertion direction for connection with a card, an opening portion provided on the front end of the socket in the card insertion direction to receive a card, a guiding means for guiding the card, when the card has a width smaller than a width of the opening portion, to a proper position for connection with the connector portion. The socket has a bottom plane portion for regulating the position of the card in the thicknesswise direction of the card, a top plane portion provided in parallel to the bottom plane portion, a pair of side face portions for regulating the position of the card in a widthwise direction of the card, and an accommodation space defined by the bottom and top plane portions and side face portions for accommodating the card, wherein the socket is made of a metal sheet and the guiding means is made by processing part of the bottom and top plane and side face portions and extends slantwise toward the connector portion and continuously in parallel to the card insertion direction.

Since the guiding means is made integrally as a part of the socket of a metal sheet, the number of required parts reduced so that the manufacturing cost also is reduced. In addition, the positional precision of the guiding means increases so that the card is guided correctly to the connector without any gap or separation between the socket and the card. Moreover, the strength of the socket itself increases.

The bottom plane portion and side face portions may be integrally made as a socket body and said top plane portion may be made as a lid member attached to the socket body. In this case, it is preferable that the bottom plane portion and said lid member are engaged to each other by engagement pieces provided in the guiding means. Although the guiding means receives the contact pressure from the card, which may produce the change in the heightwise direction of the accommodation space, especially in the vicinity of the guiding means, by the resilient displacement, the change is prevented by the engagement between the bottom plane portion and the lid member by means of the engagement pieces. Consequently, the guiding precision in the thicknesswise direction is maintained.

The bottom and top plane and side face portions may be integrally made, and the bottom plane portion maybe provided in only a region corresponding to part of the top plane portion. In this case too, it is preferable that the top plane portion is engaged to the bottom plane portion by the engagement pieces provided in the guiding means so that the change in the heightwise direction in the vicinity of the guiding means is prevented and the strength of the guiding means is increased.

According to another aspect of the present invention, the socket comprises only a bottom plane portion for regulating the position of the card in the thicknesswise direction of the card, and a pair of side face portions for regulating the position of the card in the widthwise direction of the card. Namely, no top plane portion is provided in the socket. Alternatively, the socket is fixed to a circuit board in parallel to the bottom plane portion and spaced from the bottom plane portion by a predetermined distance equal to a thickness of the card to provide an accommodation portion, which is defined by the bottom plane portion, the side face portions, and the circuit board for accommodating said card. In this case, the circuit board regulates the position of the card in the thicknesswise direction of the card together with the bottom plane portion.

In the present invention, the guiding means comprises a first guiding means on a front side of the socket and a second guiding means on a rear side of the socket, wherein the first and second guiding means are provided in either the bottom or top plane portion. In this case, the first guiding means abuts against a raised portion provided at a front end of the card within a range of height of the raised portion and the second guiding means abuts against the raised portion outside the range of height of the raised portion.

The first guiding means may have a sectional shape of a projection or a difference in level.

In the socket, either a first card having a substantially same width at front and rear sides thereof or a second card having a width at a front side thereof equal to that of the first card and a width at a rear side thereof enlarged at one side to become larger than that of the first card is selected, and when the first card is inserted into the socket, the front side of the first card is guided by the guiding means to the proper position for connection with the connector portion.

As described above, in the present invention, since the guiding means is provided by processing part of the socket of a metal sheet, the manufacturing cost is reduced. Also, since the conventional overall precision error accumulated by a plurality of required parts is minimized by minimizing the number of required parts in this invention, a gap between the parts is controlled, and since the parts are made of a metal, the strength of the socket increases. Consequently, the card is inserted and guided smoothly to the proper position for connection with the connector. Moreover, the risk for damage to the card or socket is reduced upon the insertion operation.

### BRIEF DESCRIPTION OF THE DRAWINGS

FIG. 1 is an exploded perspective view of a socket for cards according to the first embodiment of the present invention;

FIGS. 2(A) and 2(B) are sectional views of a guiding means taken along the line II-II of FIG. 1, wherein 2(A) shows an example of the guiding means made by protruding process and 2(B) shows an example of the guiding means made by forming a groove and protruding an edge of the groove;

FIG. 3 is a perspective view of a socket according to the second embodiment of the present invention;

FIG. 4 is a perspective view of a socket according to the third embodiment of the present invention;

FIG. 5 is a sectional view of a first guiding means taken along the line V-V of FIG. 4;

FIG. 6 is a perspective view of a socket according to the fourth embodiment of the present invention;

FIGS. 7(A) and 7(B) are perspective views of two different cards to be inserted into the socket according to the present invention, wherein 7(A) shows a socket having a small width (narrow card) and 7(B) shows a socket having a large width (wide card);

FIG. 8 is an exploded perspective view of a conventional socket; and

FIG. 9 is a top plan view showing insertion of the narrow card into the socket of FIG. 8.

### DETAILED DESCRIPTION OF THE PRESENT INVENTION

The embodiments of the present invention will now be described with reference to the attached drawings.

### FIRST EMBODIMENT

There are several kinds of cards having different dimensions of width, which are inserted into a socket according to the present invention. The first type of card is a narrow card. The front side, which is connected to a connector, of the narrow card has a width equal to that of the connector. The width of the narrow card is the same everywhere from the front side to the rear side thereof. The second type is a wide card. The width on the front side of the wide card is the same as that of the narrow card, that is, the same as that of the connector, but the width on the rear side is larger than that on the front side. Namely, the width of the wide card is enlarged, in a step-like form on one side in the middle portion of the card, from the small width on the front side to the large width on the rear side thereof. Also, the third type may be considered, wherein the width on the rear side of the third type has a length intermediate between those of the first and second types.

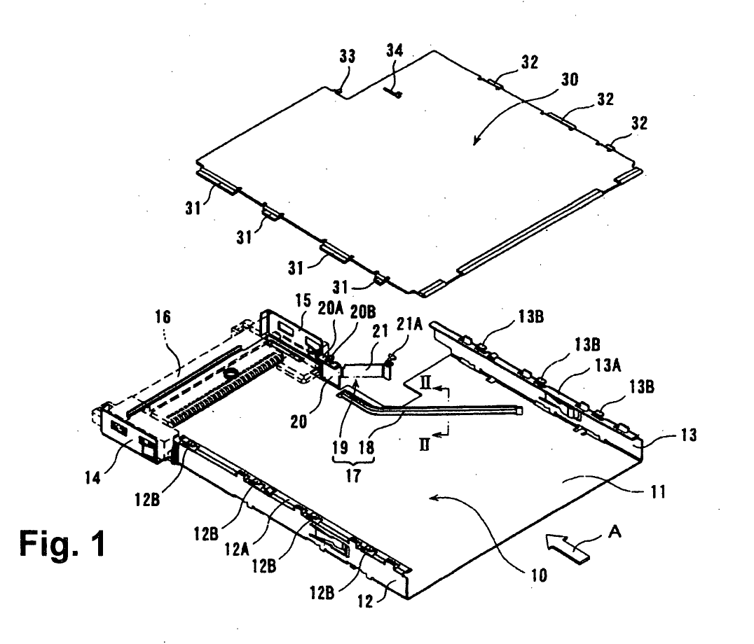

In FIG. 1, the socket comprises a socket body 10 mounted on a circuit board (not shown) and a lid member 30 to be fixed to the socket body 10. An accommodation space for receiving the cards is provided when the lid member 30 is fixed to the socket body 10. The accommodation space is commonly used for both the narrow and wide cards. The socket body 10 and the lid member 30 are made by bending and processing a metal sheet.

The socket body 10 is composed of a bottom plane portion 11 provided in parallel to a card insertion direction A and left-hand and right-hand side face portions 12 and 13 standing at the left- and right-hand edges of the bottom plane portion 11. The socket body 10 is cut off at the rear right-hand corner thereof and, therefore, the width of the rear portion of the socket body 10 is smaller than that of the front portion thereof. A pair of side support walls 14 and 15 stands on the bottom plane portion 11 on the left- and right-hand sides of the rear portion to hold a connector 16. The connector 16 has a plurality of terminals (not shown) arranged in the widthwise direction thereof. The respective terminals comprise connection portions extending rearwardly to be connected with a circuit board and contact portions extending forwardly to be connected with either narrow or wide card inserted into the accommodation space.

The bottom plane portion 11 forms a substantially flat surface extending between the side support walls 14 and 15 on the rear side of the socket body 10 and between the side face portions 12 and 13 on the middle and front sides of the socket body 10.

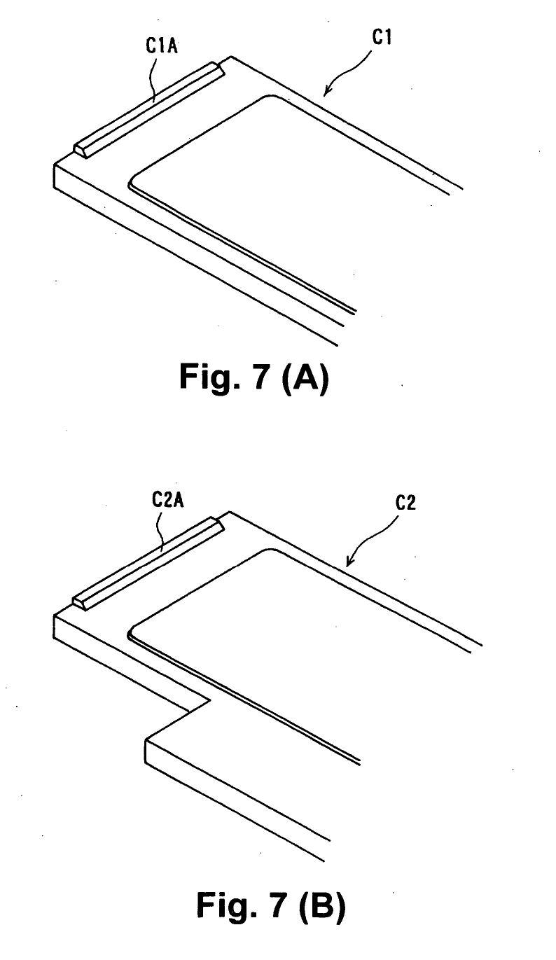

When the narrow card C1 shown in FIG. 7 is inserted into the socket body 10, it is unstable in the socket body 10 in the widthwise direction thereof because the width thereof is smaller than that of the bottom plane portion 11 on the front side of the socket body 10. Accordingly, the bottom plane portion 11 is provided with a guide portion 17 as a guiding means for guiding the narrow card C1 to a proper position in the widthwise direction of the card C1 corresponding to the position of the connector 16. The guide portion 17 has a first guide portion 18 and a second guide portion 19, both of which are provided on the right-hand side of the connector 16. The first guide portion 18 is provided in front of the second guide portion 19, that is, on the side of an opening of the socket adapted for the insertion of the card.

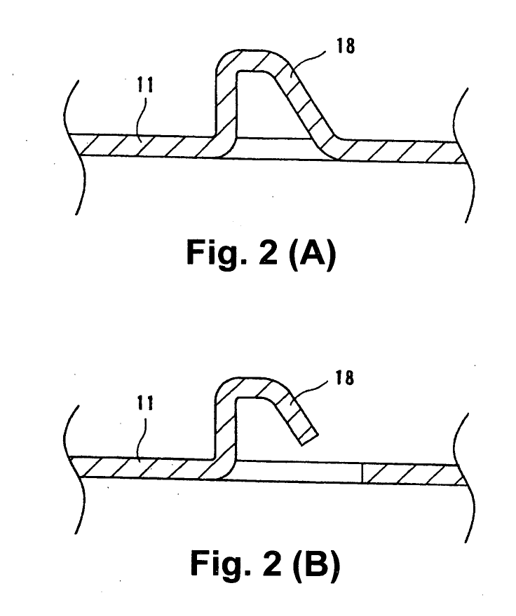

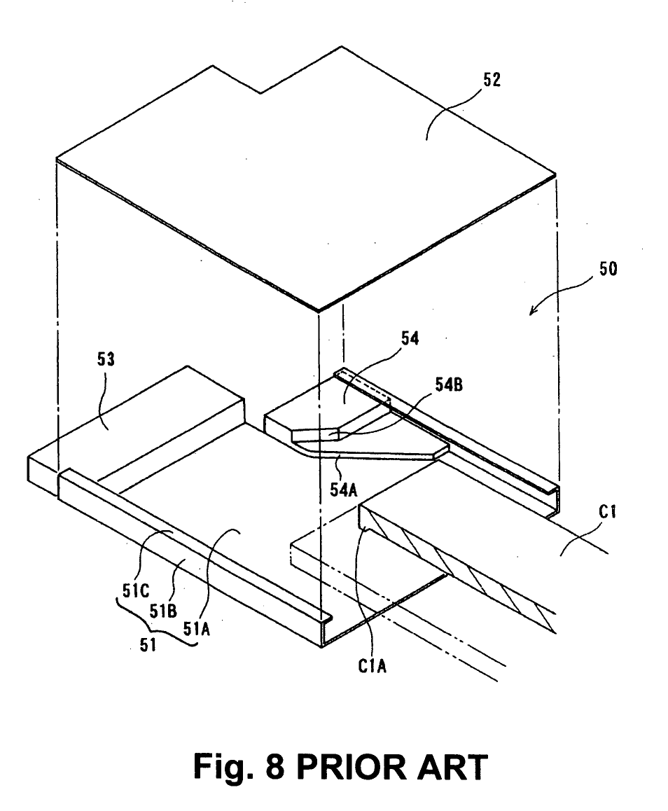

The first guide portion 18 includes a first slanted segment extending toward the connector 16 and a second segment extending from the first segment in parallel to the card insertion direction A. The first guide portion 18 extends up to the vicinity of the second guide portion 19 and the second segment is shorter than the first segment. As shown in FIGS. 2(A) and 2(B), the first guide portion 18 has a sectional shape of a protrusion projecting to the inside of the socket. The protrusion is made by protruding and bending the bottom plane portion 11 from the lower surface thereof (FIG. 2(A)), or cutting the bottom plane portion 11 to form a groove and bending an edge of the groove (FIG. 2(B)). It is preferable that a side face of the protrusion for guiding the card (left-hand side in the drawings) stands upright on the bottom plane portion 11. The height of the protrusion of the first guide portion 18 is set such that the protrusion abuts against the raised portion C1A of the narrow card C1 shown in FIG. 8 within the range of the height of the raised portion C1A. The first and second segments of the first guide portion 18 are usually formed continuously but may be formed interruptedly to the extent that the interruption does not interfere with the guiding function.

A wall portion 20, which is made by bending the side edge of the bottom plane portion 11, is provided at the vicinity of the rear end of the first guide portion 18. The second guide portion 19 has a guide tongue 21 extending forwardly and diagonally in the direction same as that of the first segment of the first guide portion 18 from the wall portion 20. That is, the guide tongue 21 has a base portion at the boundary section between the wall portion 20 and the guide tongue 21. The height of the guide tongue 21 is set such that the guide tongue protrusion 21 abuts against the raised portion C1A of the narrow card C1 outside the range of height of the raised portion C1A.

It is preferable that a flat receiving portion 20A is provided, by bending the upper edge of the wall portion 20, for receiving the lid member 30. Also, it is preferable that engagement pieces 20B and 21A are provided for engagement with the lid member 30, which project upwardly from the receiving portion 20 and the distal free end of the guide tongue 21, respectively.

Similarly, flat receiving portions 12A and 13A are provided, by bending the upper edges of the side portions 12 and 13, for receiving the lid member 30. Engagement pieces 12B and 13B project upwardly from the receiving portions 12A and 13A for engagement with the lid member 30.

The engagement pieces 20B, 21A, 12B, and 13B are formed, for example, by bending part of the receiving portion 20, guide tongue 20, receiving portions 12A and 13A, respectively, for engagement with corresponding engagement portions of the lid member 30. However, any other forming methods and shapes are acceptable as long as they function as engagement pieces, and further details thereof will be omitted.

The lid member 30 is, as shown in FIG. 1, a flat plate to function as a top face portion of the socket, having a plan view substantially same as that of the socket body 10. The lid member 30 comprises crank-shaped engagement portions 31 and 32 at side edges thereof at positions corresponding to the engagement pieces 12B and 13B. The engagement pieces 12B and 13B are engaged with the engagement portions 31 and 32.

The lid member 30 further comprises an engagement portion 33 and an engagement groove 34 at positions corresponding to the engagement pieces 20B and 21A, respectively, to engage with them. The engagement piece 20B of the wall portion 20 is engaged with the engagement portion 33. On the other hand, the engagement piece 21A of the guide tongue 21 is passed through the engagement groove 34 and bent for engagement with the engagement groove 34. Thus, since the top plane portion (lid member 30) and the bottom plane portion 11 are integrated in the vicinity of the second guide portion 19, the high precision in the heigthwise direction is obtained.

The socket is used as follows:

(1) First, the lid member 30 is fixed to the socket body 10 to provide the socket for cards, then, the socket is fixed to a circuit board. However, the assembly order may be reverse, that is, the socket body 10 may be fixed to the circuit board, and then, fixed to the lid member 30.

(2) Either the wide card C2 (FIG. 7(B)) or the narrow card C1 (FIG. 7(A)) is selected and inserted into the socket on the condition reverse to the condition shown in FIG. 7, that is, the card in FIG. 7 is inserted into the socket upside down as shown in FIG. 8. In case of the wide card C2, the card C2 is unstable in the widthwise direction in the socket at the beginning of insertion into the socket because the width on the front side thereof is smaller than the width of the socket. However, with the progress of insertion, the user can bring the card C2 into the proper position for connection with the connector by observation because the width on the middle and rear side of the card C2 is the same as the width of the socket. Even if the user is not conscious of it, the card C2 is brought to the proper position with the guidance of the side face portions 12 and 13.

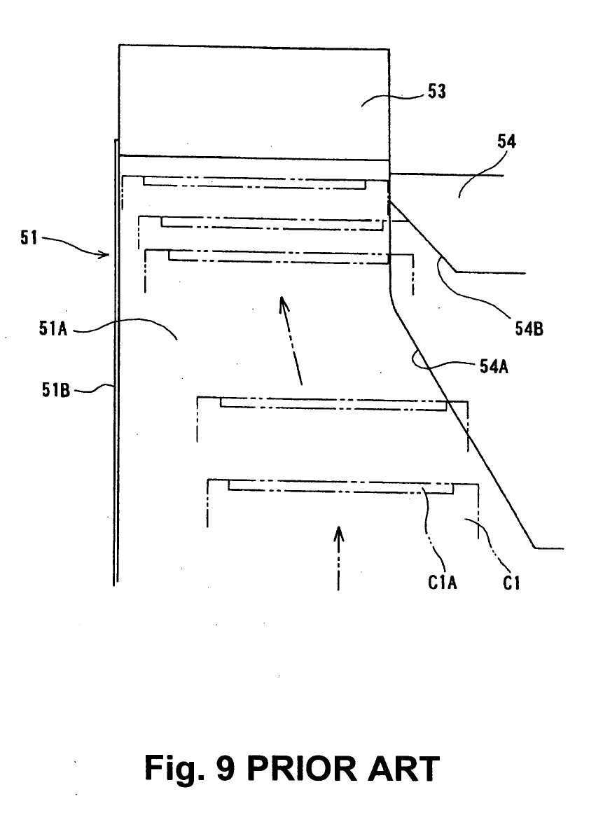

(3) In case of the narrow card C1, the card C1 is unstable in the socket in the widthwise direction because the width of the card C1 is everywhere smaller than the width of the socket. If the narrow card C1 is inserted to the right-hand side off the proper position in the widthwise direction, the right-hand end of the raised portion C1A of the card C1 abuts against the protrusion of the first slanted segment of the first guide portion 18 so that the card C1 is guided to the left-hand side, and the front right-hand corner of the card C1 abuts against the second guide portion 19 so that the card C1 is further guided to the left-hand side. Moreover, the card C1 is further guided by the protrusion of the second segment of the first guide portion 18 to the proper position for the connection with the connector 16. The condition of the guidance described above is the same as that of the conventional example shown in FIG. 9, wherein only the difference of the present invention from the conventional example is that the guiding means of the present invention is formed integrally with the case by bending a metal sheet.

### SECOND EMBODIMENT

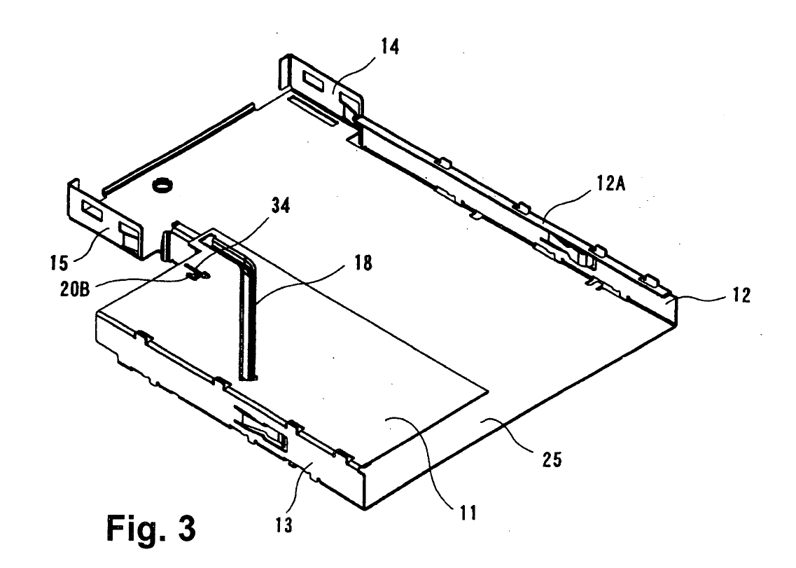

In the first embodiment shown in FIG. 1, the lid member is fixed to the socket body to provide the socket. In the second embodiment shown in FIG. 3, no lid member is used to provide the socket. In FIG. 3, such elements as commonly used in FIG. 1 have the same reference numerals and description thereof will be omitted (this rule will be applied in the other embodiments described below). In FIG. 3, the socket is illustrated upside down to facilitate understanding of the guiding means. Accordingly, the bottom plane portion is positioned upward and the top plane portion downward, and the right- and left-side is also reversed.

In FIG. 3, the socket made by processing a metal sheet comprises the bottom plane portion 11, top plane portion 25, side face portions 12 and 13, and side support walls 14 and 15. The connector (not shown) is provided between the side support portions 14 and 15.

The bottom plane portion 11 extends from the side face portion 13 up to the substantially central position in the extension direction thereof and is opened at the central position. The first guide portion 18 and the second guide portion 21 are provided in the bottom plane portion 11. The first guide portion 18 projects into the inside of the socket in the same way as in FIG. 1. However, in FIG. 3, the first guide portion 18 projects downwardly because it is illustrated upside down. The second guide portion 21 is not seen in FIG. 3 because it is concealed behind the bottom plane portion 11. If the socket in FIG. 3 is turned over to the same posture as shown in FIG. 1, the first and second guide portions 18 and 21 are shown on the bottom plane portion 11 in the same way as shown in FIG. 1.

For actual application of the socket, the bottom plane portion 11 in FIG. 3 is fixed onto a circuit board or a plane portion of another socket after turned over. It is often difficult to insert the card into the socket smoothly because a difference in level between the surfaces of the circuit board and the bottom plane portion 11 is produced, which is equal to the thickness of the bottom plane portion 11. In such a case, a sliding projection (not shown), for example, can be provided on the side face portions 12 and 13 at positions on the circuit board side, to raise the card by the difference in level equal to the thickness of the bottom plane portion 11.

In this embodiment, a circuit board may be fixed onto the bottom plane portion 11 in FIG. 3 without turning over the bottom plane portion 11. In the case, since there is provided a play in the thicknesswise direction between the card and the case, the difference in level caused by the thickness of the bottom plane portion 11 gives no influence on the insertion of the card so that it is not necessary to provide the sliding projection. However, the positions of the first and second guide portions 18 and 21 must be arranged slightly downward so that they abut against the card, which has been inserted downward because of the play. The bottom plane portion 11 may extend in the widthwise direction up to the right side face portion 12 to engage each other.

### THIRD EMBODIMENT

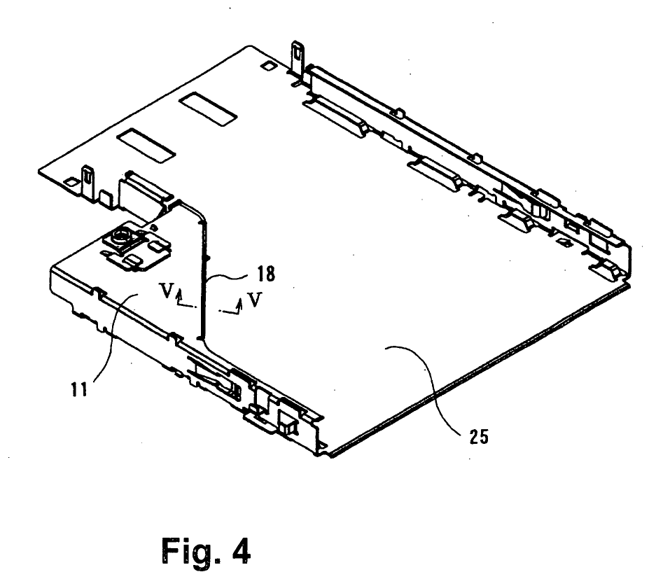

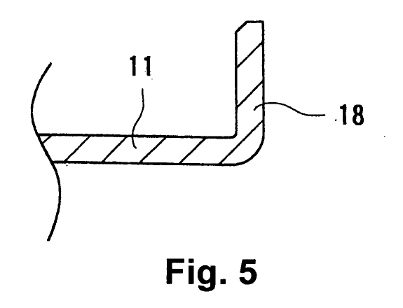

In the second embodiment in FIG. 3, the bottom plane portion 11 extend up to the center in the widthwise direction. In the third embodiment in FIG. 4, however, the bottom plane portion 11 is provided only at a triangular region on the front side. The first guide portion 18 is provided at an edge of an oblique side of the triangular region. The first guide portion 18 is made, as shown in FIG. 5, by bending the edge upwardly. When the socket in FIG. 4 is turned over in the same way as described in the second embodiment and fixed onto a circuit board, the bottom plane portion 11 itself projects to the inside of the socket and the external face of the edge of the first guide portion 18 guides the card.

In the third embodiment too, the circuit board may be fixed onto the bottom plane portion 11 without turning over the socket in FIG. 4.

### FOURTH EMBODIMENT

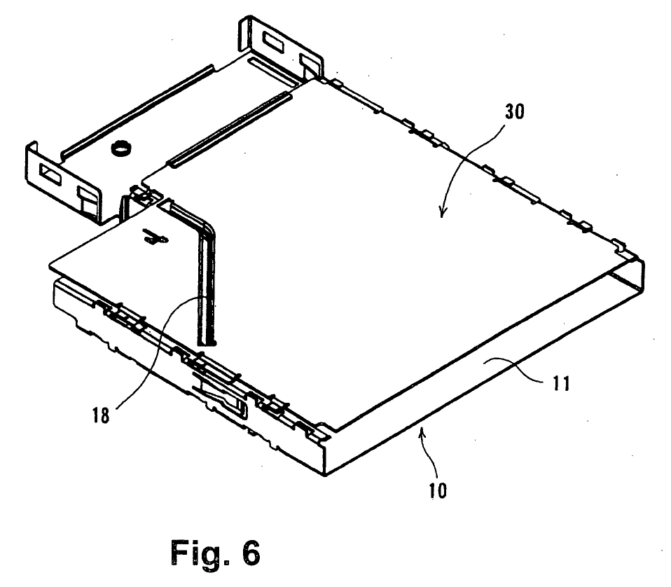

In the fourth embodiment in FIG. 6, the socket comprises the socket body 10 and the lid member 30 in the same way as described in the first embodiment in FIG. 1. However, unlike the first embodiment, the guiding means is provided in the lid member 30. The guiding means has the first guide portion 18 and the second guide portion 21 (not shown in FIG. 6), like the first embodiment, and when the socket is turned over upside down, the first and second guide portions 18 and 21 are of the same shapes as those in the first embodiment.

Also, the socket may be fixed onto a circuit board from the above or from the underside in the same way as described in the second and third embodiments.

The present invention is not limited to the embodiments shown in the drawings and various modifications are possible. For example, it is not always necessary that the guiding means has two portions, the first and second guide portions. The two guiding portions may be united as one successive member. The importance is that the guiding means according to the present invention is integrally made with a socket by using a metal sheet, and the narrow card having a width on the front side thereof smaller than that of the socket is guided by the guiding means to the proper position in the widthwise direction for connection with a connector.

Also, it is not always necessary that the guiding means, especially the first guiding means, is made as a projection. A difference in level may be provided in the bottom plane portion, as a replacement of the projection, to provide a step-shaped edge for guiding the card.

The first and second guiding means may be provided in the bottom and top plane portions, separately. The second guiding means may extend from the side face portion. In that case, the engagement pieces provided in the second guiding means may engage each of the top and bottom plane portions to integrate both the plane portions.

1. A socket for a card, said socket being made of a metal sheet, comprising:
a connector portion provided at a rear end of said socket for connection with said card;
an opening portion provided at a front end of said socket to receive said card;
a guiding means for guiding said card, when said card has a width smaller than a width of said opening portion, to a proper position for connection with said connector portion;
a bottom plane portion for regulating a position of said card in a thicknesswise direction of said card;
a top plane portion provided in parallel to said bottom plane portion;
a pair of side face portions for regulating said position of said card in a widthwise direction of said card; and
an accommodation space defined by said bottom and top plane portions and side face portions for accommodating said card, wherein said guiding means is made by processing part of at least one of said bottom and top plane and side face portions and extends slantwise toward said connector portion and continuously in parallel to an insertion direction of said card.

2. The socket according to claim 1, wherein said bottom plane portion and said side face portions integrally form a socket body and said top plane portion is formed by a lid member attached to said socket body.

3. The socket according to claim 2, wherein said bottom plane portion of said socket body is engaged to said lid member by engagement pieces provided in said guiding means.

4. The socket according to claim 1, wherein said bottom and top plane and side face portions are integrally formed.

5. The socket according to claim 4, wherein said bottom plane portion is provided only at a region corresponding to part of said top plane portion.

6. The socket according to claim 4, wherein said top and bottom plane portions are engaged to each other by engagement pieces provided in said guiding means.

7. A socket for a card, said socket being made of a metal sheet, comprising:
a connector portion provided at a rear end of said socket in an insertion direction of said card for connection with said card;
an opening portion provided at a front end of said socket in said card insertion direction to receive said card;
a guiding means for guiding said card, when said card has a width smaller than a width of said opening portion, to a proper position for connection with said connector portion;
a bottom plane portion for regulating a position of said card in a thicknesswise direction of said card; and
a pair of side face portions for regulating said position of said card in a widthwise direction of said card, wherein when said socket is fixed to a circuit board in parallel to said bottom plane portion and spaced from said bottom plane portion by a predetermined distance equal to a thickness of said card, an accommodation space is defined by said bottom plane portion, said side face portions, and said circuit board, and said guiding means is made by processing part of at least one of said bottom plane portion and side face portions and extends slantwise toward said connector portion and continuously in parallel to said card insertion direction.

8. The socket according to claim 1, wherein said guiding means comprises a first guiding means on a front side of said socket and a second guiding means on a rear side of said socket, said first and second guiding means provided in either said bottom or top plane portion.

9. The socket according to claim 7, wherein said guiding means comprises a first guiding means on a front side of said socket and a second guiding means on a rear side of said socket, said first and second guiding means provided in either said bottom or top plane portion.

10. The socket according to claim 8, wherein said first guiding means abuts against a raised portion provided at a front end of said card within a range of height of said raised portion and said second guiding means abuts against said raised portion outside said range of height of said raised portion.

11. The socket according to claim 9, wherein said first guiding means abuts against a raised portion provided at a front end of said card within a range of height of said raised portion and said second guiding means abuts against said raised portion outside said range of height of said raised portion.

12. The socket according to claim 8, wherein said first guiding means has a sectional shape of a projection or a difference in level.

13. The socket according to claim 9, wherein said first guiding means has a sectional shape of a projection or a difference in level.

14. The socket according to claim 8, wherein said first guiding means has a first segment extending slantwise toward said connection portion and a second segment extending from said first segment in parallel to said card insertion direction.

15. The socket according to claim 9, wherein said first guiding means has a first segment extending slantwise toward said connection portion and a second segment extending from said first segment in parallel to said card insertion direction.

16. The socket according to claim 1, when a first card having a substantially same width on front and rear sides thereof is inserted into said socket, said front side of said first card is guided by said guiding means to said proper position for connection with said connector portion.

17. The socket according to claim 7, when a first card having a substantially same width on front and rear sides thereof is inserted into said socket, said front side of said first card is guided by said guiding means to said proper position for connection with said connector portion.
